(19) United States
(12) Patent Application Publication
(10) Pub. No.: US 2014/0052380 A1
(43) Pub. Date: Feb. 20, 2014

(54) METHOD AND APPARATUS FOR ANALYZING PERSONALIZED MULTI-OMICS DATA

(71) Applicant: SAMSUNG ELECTRONICS CO., LTD., Suwon-si (KR)

(72) Inventors: Dae-soon SON, Seoul (KR); Tae-jin AHN, Seoul (KR); Eun-jin LEE, Seoul (KR); Jong-suk CHUNG, Hwaseong-si (KR)

(73) Assignee: SAMSUNG ELECTRONICS CO., LTD., Suwon-si (KR)

(21) Appl. No.: 13/750,080

(22) Filed: Jan. 25, 2013

(30) Foreign Application Priority Data
Aug. 16, 2012 (KR) 10-2012-0089667

(51) Int. Cl. G06F 19/10

(52) U.S. Cl. CPC G06F 19/10
USPC 702/19

(57) ABSTRACT

A method and apparatus for analyzing personalized multi-omics data are disclosed. The method includes acquiring a plurality of biological data groups from an individual's gene sample, estimating indices indicating a degree of genetic abnormalities for the biological data groups, and generating a combined index by merging the estimated indices.

### CROSS-REFERENCE TO RELATED APPLICATIONS

This application claims the benefit of Korean Patent Application No. 10-2012-0089667, filed on Aug. 16, 2012, in the Korean Intellectual Property Office, the disclosure of which is incorporated herein in its entirety by reference.

### BACKGROUND

1. Field

The present disclosure relates to methods and apparatuses for analyzing personalized multi-omics data by combining different types of genetic information into a single representation.

2. Description of the Related Art

A genome is the entirety of a living organism's genetic information. As techniques for sequencing the genome of an individual have continued to evolve, various novel sequencing methods such as Next Generation Sequencing and Next Next Generation Sequencing are being developed. Genetic information containing nucleic acid sequences and protein are widely used to identify genes causing diseases such as diabetes and cancer or to detect correlations between genetic variations and characteristics expressed in an individual. Genetic information collected from an individual is crucial for identifying the genetic characteristics of an individual related to the onset or progression of different symptoms or diseases. Thus, by providing information about a present illness or the future likelihood of some diseases, personal genome information such as nucleic acid sequences or protein plays an important role in determining the best treatment at the early stages of a disease if it is present or in preventing the occurrence of disease. Due to its growing importance, research is being conducted on techniques for precisely analyzing personal genome information using a genome detecting device such as a DNA chip or microarray for detecting single nucleotide polymorphisms (SNP) and copy number variation (CNV) as genomic information of a living organism.

### SUMMARY

Provided are methods and apparatuses for analyzing personalized multi-omics data by integrating different types of biological data. Also provided is a computer readable recording medium having recorded thereon a computer program for executing the above methods.

According to an aspect of the present invention, a method of analyzing personalized multi-omics data includes: acquiring a plurality of biological data groups containing different types of genome data from an individual's gene sample; estimating indices indicating a degree of genetic abnormalities in each of the different types of genomic data for each of the plurality of biological data groups; and generating a combined index which evaluates the degree of genetic abnormalities for the entire biological data groups by using an analysis algorithm for generalizing the estimated indices.

According to another aspect of the present invention, a method of analyzing personalized multi-omics data includes: estimating indices indicating a degree of genetic abnormalities for each of a plurality of different biological data groups obtained from an individual's gene sample; obtaining a confidence value for each of the plurality of biological data groups from genome data measurement platforms used to obtain the plurality of biological data groups; and reflecting the confidence values in the estimated indices to generalize the estimated indices and generating a combined index which evaluates the degree of genetic abnormalities for the entire biological data groups.

According to another aspect of the present invention, a non-transitory computer-readable recording medium having recorded thereon a program for executing the method of analyzing personalized multi-omics data is provided.

According to another aspect of the present invention, an apparatus for analyzing personalized multi-omics data includes: a data acquisition unit for acquiring a plurality of biological data groups containing different types of genome data from an individual's gene sample; an index estimation unit for estimating indices indicating a degree of genetic abnormalities in each of the different types of genomic data for each of the plurality of biological data groups; and a combined index generation unit for generating a combined index which evaluates the degree of genetic abnormalities for the entire biological data groups by using an analysis algorithm for generalizing the estimated indices.

According to another aspect of the present invention, an apparatus for analyzing personalized multi-omics data includes: an index estimation unit for estimating indices indicating a degree of genetic abnormalities for each of a plurality of different biological data groups obtained from an individual's gene sample; a data acquisition unit for obtaining a confidence value for each of the plurality of biological data groups from genome data measurement platforms used to obtain the plurality of biological data groups; and a combined index generation unit for reflecting the confidence values in the estimated indices to generalize the estimated indices and generating a combined index which evaluates the degree of genetic abnormalities for the entire biological data groups.

As described above, the method and apparatus for analyzing personalized multi-omics data allows personalization of genomic information obtained from an individual's gene sample for analysis, thereby providing precise detection of genetic abnormalities in an individual's genome. The method and apparatus may also combine or merge different kinds of genome information derived from an individual's gene sample for analysis, thereby allowing more precise and efficient analysis of individual's genome information compared to the use of a single type of data.

### BRIEF DESCRIPTION OF THE DRAWINGS

These and/or other aspects will become apparent and more readily appreciated from the following description of the embodiments, taken in conjunction with the accompanying drawings of which:

FIG. 1 is a diagram that illustrates a configuration of a system for analyzing personalized multi-omics data;

FIG. 2A is a diagram of an apparatus for analyzing personalized multi-omics data;

FIG. 2B is a diagram explaining confidence values for biological data groups;

FIG. 3A is a flowchart of a process of estimating an index for a biological data group related to mutation in an index estimation unit of the apparatus of FIG. 2A;

FIG. 3B is a flowchart of a process of estimating an index for a biological data group related to messenger ribonucleic acid (mRNA) expression in the index estimation unit of the apparatus of FIG. 2A;

FIG. 3C is a flowchart of a process of estimating an index for a biological data group related to Copy Number Variation (CNV) in the index estimation unit of the apparatus of FIG. 2A;

FIG. 4A is a diagram that illustrates estimation of an index by using a normal distribution in the index estimation unit of the apparatus of FIG. 2A;

FIG. 4B is a diagram that illustrates estimation of an index by using an empirical distribution in the index estimation unit of the apparatus of FIG. 2A;

FIG. 5 is a diagram that illustrates a combined index p-value_{combine};

FIG. 6A is a schematic diagram for explaining a method of analyzing personalized multi-omics data;

FIG. 6B is a diagram for fully explaining a method of analyzing personalized multi-omics data;

FIG. 6C is a diagram for explaining application of a method of analyzing personalized multi-omics data for each gene; and

FIG. 7 is a flowchart of a method of analyzing personalized multi-omics data.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

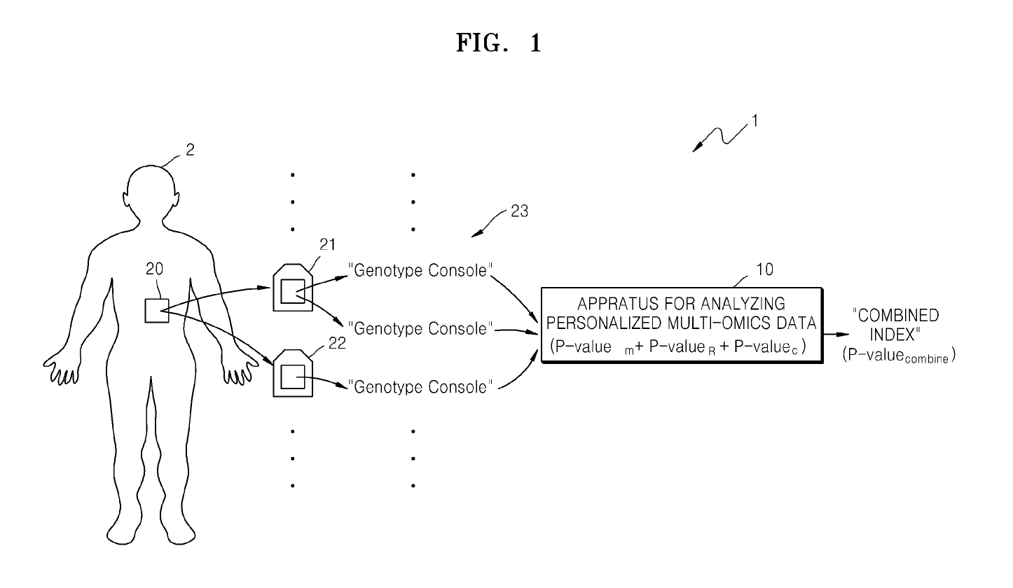

FIG. 1 illustrates a configuration of a system 1 for analyzing personalized multi-omics data, according to an exemplary embodiment of the present invention. Referring to FIG. 1, the system 1 uses an apparatus 10 for analyzing personalized multi-omics data to analyze a gene sample 20 derived from a patient 2. Only components related to the present embodiment are shown in FIG. 1 in order to avoid obscuring the features of the present embodiment. However, the system 1 may further include other common components than those shown in FIG. 1.

The system 1 uses microarrays 21 and 22 such as DNA chips and a sequencing tool 23 such as Genotype Console or Expression Console to obtain various types of genome information including nucleic acid sequences and protein sequences from the gene sample of a patient 2. The gene sample can be any type of sample containing genetic information (e.g., DNA, RNA, or protein), such as blood, saliva, or other samples (e.g., tissue or fluid samples) of the body. Thus, the system 1 may use different measurement platforms to obtain various types of genome information.

The details of the processes of obtaining various kinds of genome information about nucleic acids and protein contain in a sample by using measurement platforms such as the microarrays 21 and 22 and the sequencing tool 23 are known to those of ordinary skill in the art, and a detailed description thereof is omitted, accordingly.

The system 1 may employ measurement platforms other than the microarrays 21 and 22 and the sequencing tool 23 so long as they can obtain various types of genome information such as information about nucleic acids and protein.

Nucleic acids contain genome information about an individual and are divided into two types; DeoxyriboNucleic Acid (DNA) and RiboNucleic Acid (RNA). The DNA is a genetic material, i.e., a gene, including individual's genome information. A DNA sequence contains information about cells and tissues of an individual, and bases in the DNA sequence represent information about the order in which 20 types of amino acids in a protein of an individual are joined together or aligned. That is, the protein is a product produced from nucleic acid and expressed in various types according to an individual's DNA sequence.

Genome information such as an individual's DNA sequence and protein is useful for understanding biological phenomena and obtaining information about an individual's disease. Thus, comparing a DNA sequence in a patient's gene with a DNA sequence from a normal gene for analysis may prevent occurrence of an individual's illness or facilitate choosing the best treatment at the early stages of a disease.

The system 1 analyzes the patient's genome information to detect genetic abnormalities. To achieve this, the apparatus 10 for analyzing personalized multi-omics data in the system 1 personalizes biological data groups related to various types of genome information such as information about nucleic acids and protein derived from the gene sample 20 and combines the results for analysis.

‘Omics’ refers to a field of study in biology, encompassing, e.g., genomics, proteomics, transcriptomics, and metabolomics. Multi-omics refers to genetic information gathered from multiple sources. For instance, multi-omics data might include information regarding DNA (e.g., sequence, single nucleotide polymorphism, mutation, copy number variation, etc.), RNA (e.g., sequence, mutation, copy number variation, etc.), and/or protein sequence (sequence, mutation, expression level, etc) relating to a gene or group of genes.

A biological data group, as used herein, refers to a data group comprising genome data (i.e., genomic data or “omic” data), from a given measurement platform or source and its quality score or confidence indicator. The plurality of biological data groups described in the present embodiment each contain different types of omics data sets originating from the gene sample 20 and, thus, collectively contain multi-dimensional genetic information, for instance Single Nucleotide Polymorphism (SNP), Copy Number Variations (CNV), mutation information, mRNA expression data or the results of proteome analysis to identify genetic phenomena such as how a gene functions after the gene is turned into a protein, or Transcriptome analysis to identify genetic phenomena such as how a gene will function during transition from a gene to a protein.

In one embodiment, each of the plurality of biological data groups contain different omics data regarding a particular gene or group of genes. More specifically, the plurality of data groups may include two or more different data groups each comprising data about mutation, SNP, CNV, insertion, deletion, gene expression, DNA methylation, protein expression, protein targeting, protein phosphorylation, and protein binding.

The system 1 and the apparatus 10 according to the present embodiment personalizes the biological data groups and integrally combines or merges the results for analysis. By relying upon multiple different types of omics data, the system, apparatus, and method described herein enables more precise, accurate, and/or efficient detection of abnormalities in an individual's genome.

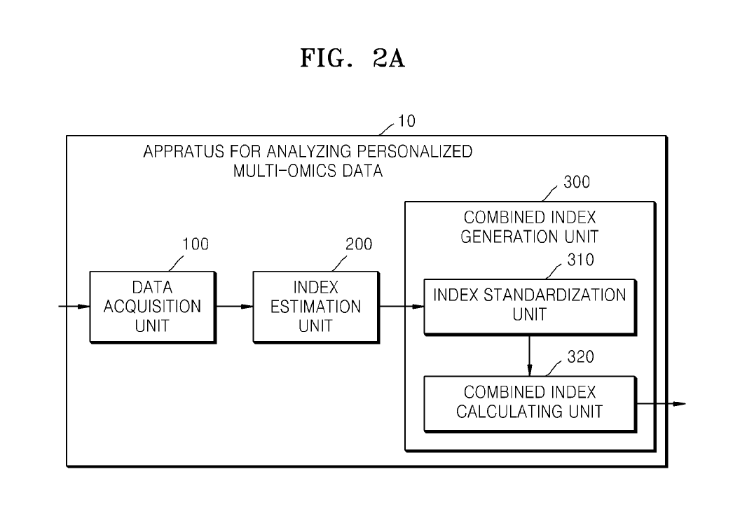

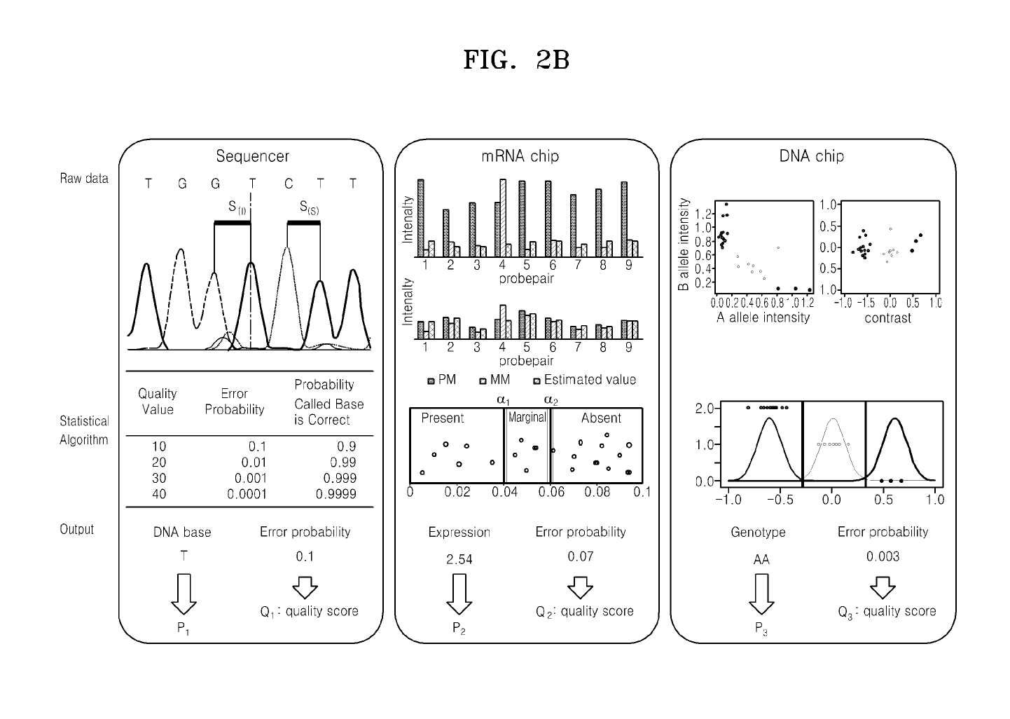

The system 1 and the apparatus 10 combine or merge the plurality of biological data groups by using confidence values of the data included in the biological data groups. The details of this process are described by reference to embodiments of the invention in the following paragraphs. FIG. 2A illustrates a method and a configuration of an apparatus for analyzing multi-omics data 10. Referring to FIG. 2A, the apparatus 10 includes a data acquisition unit 100, an index estimation unit 200, and a combined index generation unit 300. The combined index generation unit 300 includes an index standardization unit 310 and a combined index calculating unit 320. In order to avoid obscuring the gist of the present embodiment, FIG. 2A illustrates only hardware components in the apparatus 10. However, it will be understood by those of ordinary skill in the art that the apparatus 10 may also include common hardware components other than those illustrated in FIG. 2A. In particular, the apparatus 10 may be embodied as a processor, which may be realized by an array of a plurality of logic gates or a combination of a general-purpose microprocessor and a memory having stored thereon a program to be executed on the microprocessor. Furthermore, it will be understood by those of ordinary skill in the art that the processor may be embodied in other types of hardware.

The data acquisition unit 100 acquires a plurality of biological data groups at least two or more of which contain different kinds of genetic information (e.g., different types of omics data, as discussed above, from the patient's gene sample 20.

The data acquisition unit 100 also obtains a confidence value for each biological data group, which may be a measure of precision and/or accuracy for the data of biological data group. More specifically, each of the biological data groups is acquired from a particular platform or software, e.g., a sequencing tool 23, such as Genotype Console and Expression Console, together with a confidence value or quality measure describing how reliable (e.g., precise and/or accurate) the acquired data is. That is, the confidence value may be information based on a quality score produced by measurement platforms used to obtain different types of biological data groups.

In the present embodiment, the confidence value is used as a weight assigned to an index for each of different types of biological data groups. As will be described later, if data sets are acquired by different sequencing tools 23 and then normalized based on confidence values, as described above, the data sets may be compared with each other.

For example, when SNP or CNV calling is performed using Affymetrix SNP6.0, a confidence value may be obtained for each gene site, together with corresponding data. The confidence value may have a value between 0 and 1 and be converted into a percentile in order to normalize data. When Affymetrix U133 is used instead of SNP6.0, a detection p-value is acquired. The detection p-value indicates how reliable values absent (A), marginal (M), and present (P) for each probe are. Likewise, the detection p-value may be converted into a percentile so as to normalize data.

FIG. 2B is a diagram for explaining a confidence value for exemplary types of biological data groups. Referring to FIG. 2B, a sequencer, a messenger RNA (mRNA) chip, and a DNA chip may be used as genome information measurement platforms. The sequencer, the mRNA chip, and the DNA chip provide information about DNA bases, mRNA expression, and genotypes, respectively, and may have quality scores, i.e., information regarding the precision, accuracy, or other error information (or error probability) provided by the measurement platform vendors. A quality score may be used as a confidence value (or weight).

In describing the present embodiment, it is assumed that the plurality of biological data groups include only a biological data group related to mutation, a biological data group related to mRNA expression, and a biological data group related to CNV. However, the plurality of biological data groups are not limited thereto, and may include other types of biological data groups.

In order to obtain a biological data group related to mutation, the gene sample 20 reacts with a DNA chip (e.g., SNP 6.0), and the data acquisition unit 100 acquires the result produced by the sequencing tool 23, such as Genotype Console, and its corresponding confidence value. In order to obtain a biological data group related to mRNA expression, the gene sample 20 reacts with a DNA chip (e.g., U133 Plus2.0) and the data acquisition unit 100 acquires the result produced by the sequencing tool 23 (e.g., Expression Console) and its corresponding confidence value. Furthermore, in order to obtain a biological data group related to CNV, the gene sample 20 reacts with a DNA chip (e.g., U133 Plus2.0), and the data acquisition unit 100 acquires the result produced by the SNP 23 (e.g. Expression Console) and its corresponding confidence value. Thus, the data acquisition unit 100 obtains a plurality of biological data groups, including different types of genetic information about a gene or set of genes and corresponding confidence values.

For each of biological data groups acquired, the index estimation unit 200 estimates (calculates) indices indicating an estimated degree of genetic abnormality in each of the different types of genetic data contained therein. For convenience in describing the present embodiment, the estimated indices are p-values for statistically testing the significance with respect to the degree of genetic abnormalities. However, other statistical indices may be used.

The index estimation unit 200 statistically compares genetic data contained in the acquired biological data groups with corresponding control groups and calculates indices for the biological data groups. The control groups may be data obtained from public databases corresponding to the biological data groups (i.e., the same type of data corresponding to the same gene or set of genes), but the present invention is not limited thereto.

The index estimation unit 200 may compare genetic data with corresponding control groups by using a normal distribution or empirical distribution. In particular, the index estimation unit 200 compares genetic data of each of biological data groups with a corresponding control group by using the same type of distribution.

The index estimation unit 200 may perform the above-described processes on each gene within the genetic data contained in the biological data groups.

Processes of calculating or estimating indices in the index estimation unit 200 according to the present invention will now be described more fully with reference to FIGS. 1, 2A, 3A through 3C, 4A, and 4B.

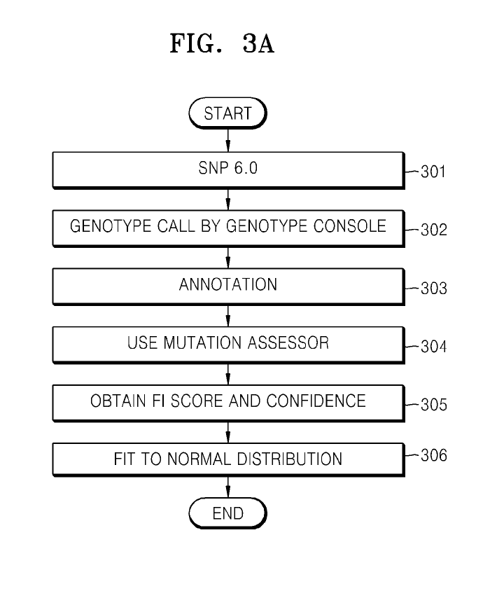

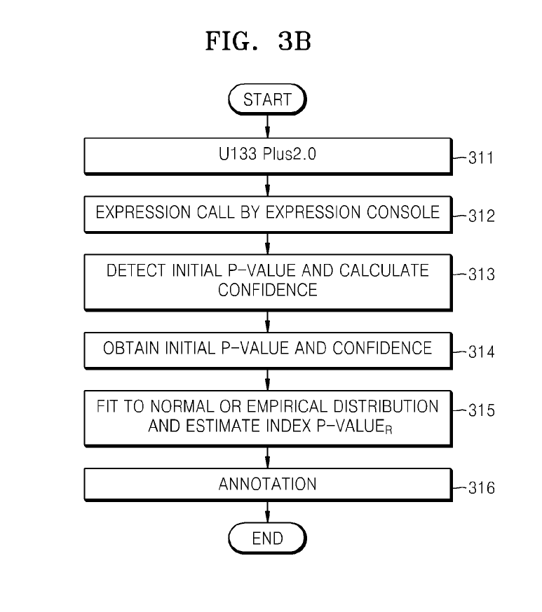

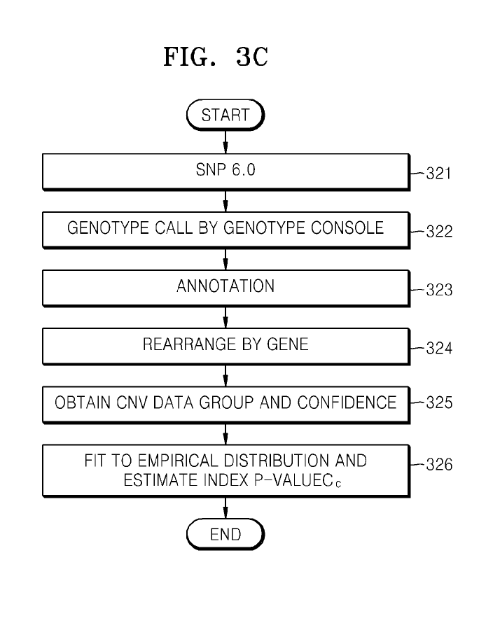

FIG. 3A illustrates a process of calculating an index for a biological data group related to mutation in the index estimation unit 200, according to an exemplary embodiment. Although a DNA chip (SNP 6.0) and sequencing tools such as Genotype Console and Mutation Assessor described with reference to FIG. 3A are measurement platforms that operate outside the apparatus 10, they are described herein together with the operation of the apparatus 10 for convenience of explanation.

A DNA chip (SNP 6.0) provides the result of a reaction with a gene sample (301).

A sequencing tool (Genotype Console) performs a Genotype Call on the result of the reaction (302).

The sequencing tool (Genotype Console) carries out annotation on the result obtained in operation 302 (303). In this case, the sequencing tool (Genotype Console) translates the result obtained in operation 302 into the name of a gene containing a mutation. For example, the sequencing tool (Genotype Console) may convert the result to an annotation such as ‘hg19.position.ref.change’.

A sequencing tool, Mutation Assessor, developed by Memorial Sloan Kettering Cancer Center (MSKCC), calculates a Fl score (functional impact score) and a confidence value for each gene (304).

The data acquisition unit 100 obtains a biological data group related to the mutation, and Fl score and a confidence value of the biological data group related to the mutation (305).

The index estimation unit 200 fits the obtained Fl score to a normal distribution (like a z-score) and calculates an index p-valueₘ (306). The process of calculating an index p-valueₘ is described in greater detail below. The index p-valueₘ may be obtained for each gene contained in the biological data group related to the mutation. The index p-valueₘ obtained for the biological data group related to the mutation from the index estimation unit 200 as des_{cr}ibed above may be used as an index that is personalᵢzed to the patient 2 for mutation.

FIG. 3B illustrates a process of estimating an index for a biological data group related to mRNA expression in the index estimation unit 200, according to an exemplary embodiment. Although a DNA chip (U133Plus2.0) and a sequencing tool such as Expression Console described with reference to FIG. 3B are measurement platforms that operate outside the apparatus 10, they are described herein together with the operation of the apparatus 10 for convenience of explanation.

A DNA chip (U133 Plus2.0) provides the result of a reaction with a gene sample (311).

A sequencing tool (Expression Console) performs an Expression Call on the result of the reaction (312).

The sequencing tool (Expression Console) uses a MicroArray Suite 5.0 (MAS5) algorithm to detect an initial p-value for each ProbeSetID from the result obtained in operation 312 and calculates a corresponding confidence value (313).

The data acquisition unit 100 obtains a biological data group related to mRNA expression, and the initial p-value and confidence value of the biological data group related to mRNA expression (314).

The index estimation unit 200 fits the obtained initial p-value to a normal distribution or an empirical distribution and estimates an index p-value_{R} (315). The process of calculating an index p-value_{R} is described in greater detail below. The index p-value_{R} may be obtained for each gene contained in the biological data group related to mRNA expression.

The index estimation unit 200 uses Gene Symbol corresponding to ProbeSetID to perform annotation on the index p-value_{R} (316). If there is an overlap between genes, the index estimation unit 200 estimates the final index p-value_{R} and its corresponding confidence value based on the index p-value_{R} having the smallest value.

As described above, the index p-valueₘ obtained for the biological data group related to a mutation from the index estimation unit 200 may be used as an index that is personalized to the patient 2 for mutation.

The index p-value_{R} obtained from the index estimation unit 200 for the biological data group related to mRNA expression as described above may be used as an index that is personalized to the patient 2 for mRNA expression.

FIG. 3C illustrates a process of estimating an index for a biological data group related to CNV in the index estimation unit 200, according to an exemplary embodiment. Although a DNA chip (U133Plus2.0) and a sequencing tool such as Expression Console described with reference to FIG. 3C are measurement platforms that operate outside the apparatus 10, they are described herein together with the operation of the apparatus 10 for convenience of explanation.

A DNA chip (SNP 6.0) provides the result of a reaction with a gene sample (321).

A sequencing tool (Genotype Console) performs a Genotype Call on the result of the reaction (322).

The sequencing tool (Genotype Console) carries out annotation on the result obtained in operation 322 (323). In this case, the sequencing tool (Genotype Console) may perform annotation (hg 18 version) on genes within the result, which is found in or partially corresponding to a CNV region.

The sequencing tool (Genotype Console) converts the result obtained in operation 323 for each gene and removes data for duplicate genes (324).

The data acquisition unit 100 obtains a biological data group related to CNV, and a confidence value of the biological data group related to CNV (325).

The index estimation unit 200 fits the obtained biological data group to an empirical distribution and estimates an index p-value_{c} (326). The process of calculating an index p-valueₛ is described in greater detail below. The index p-valueₛ obtained for the biological data group related to CNV from the index estimation unit 200 as described above may be used as an index that is personalized to the paₜient 2 for CNV.

As described above with reference to FIGS. 3A through 3C, the index estimation unit 200 estimates the indices p-valueₘ, p-value_{R} and p-valueₛ for corresponding biological data groups, respectively, by using different techniques depending on the type of a biological data group acquired. Exemplary techniques are described below. It will be understood by those of ordinary skill in the art that the DNA chips and sequencing tools in FIGS. 3A through 3C are used for purposes of illustration and explanation and different types of DNA chips and sequencing tools may be used.

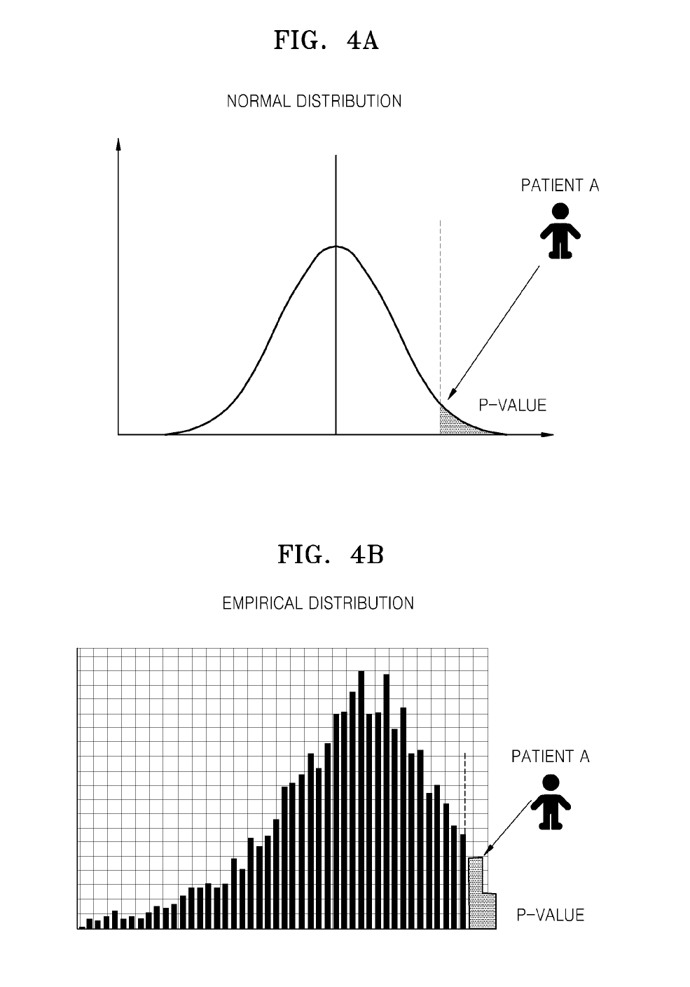

FIG. 4A illustrates estimation of an index by using a normal distribution in the index estimation unit 200, according to an exemplary embodiment of the present invention. FIG. 4B illustrates estimation of an index by using an empirical distribution in the index estimation unit 200, according to an exemplary embodiment of the present invention.

Referring to FIG. 4A, the index estimation unit 200 extracts data for normal genes from a public database and converts the data to a normal distribution. The data is of the same type (e.g., CMV, mRNA expression, mutation, etc.) and for the same gene or set of genes as that of the biological data group being analyzed. Thereafter, the index estimation unit 200 finds a point on the normal distribution where genome data of the biological data group is fit for comparison and analysis, and calculates an index p-value for the biological data group.

Referring to FIG. 4B, the index estimation unit 200 obtains data for normal genes from a public database and converts the data to an empirical distribution. The data is of the same type (e.g., CMV, mRNA expression, mutation, etc.) and for the same gene or set of genes as that of the biological data group being analyzed. Thereafter, the index estimation unit 200 finds a point on the empirical distribution where genome data contained in the biological data group is fit for comparison and analysis, and calculates an index p-value for the biological data group.

Referring to FIG. 2A, the combined index generation unit 300 uses an analysis algorithm for generalizing the estimated (calculated) indices and generates a combined index p-value_{combine} evaluating genetic abnormalities for the combined biological data groups for a given gene or group of genes. In this case, the combined index generation unit 300 reflects the confidence value for each of the biological data groups in the estimated indices to generalize the estimated indices and generates combined index p-value_{combine}.

More specifically, the index standardization unit 310 incorporates (reflects) the confidence value for each of the biological data groups obtained by the data acquisition unit 100 into the indices calculated by the index estimation unit 200, and normalizes the indices for each of the biological data groups. The combined index calculating unit 320 then generalizes the normalized indices by using an analysis algorithm for generalizing the estimated indices and produces a combined index p-value_{combine}.

The analysis algorithm used in the combined index generation unit 300 may be a meta-analysis algorithm. Examples of the generally known meta-analysis algorithm include a Fisher's inverse chi-square method, a Tippett's method (minimum p method), a Stouffer's inverse normal method, a George's method (logit method), and The Cancer Genome Atlas (TCGA) method.

The meta-analysis algorithm is used to obtain a representative p-value from a plurality of p-values. The precise methodology for applying the algorithms will be readily apparent to those of ordinary skill in the art. Furthermore, it will be understood by those of ordinary skill in the art that the combined index generation unit 300 may use any meta-analysis algorithm so long as the algorithm is designed for obtaining a representative p-value from among a plurality of p-values given for the same sample.

By way of further illustration, the combined index generation unit 300 may apply a meta-analysis algorithm as described below.

The index standardization unit 310 applies a weight corresponding to a confidence value (e.g., a confidence value converted to a percentile) for each of the biological data groups to the estimated indices and converts the estimated indices. The combined index calculating unit 320 combines or merges the indices obtained by the index standardization unit 310 and produces a combined index p-value_{combine}. This process is expressed by Equation (1):

p_{combine}=pₘ^{w}^{ₘ}·p_{R}^{w}^{_{R}}·p_{c}^{w}^{_{c}}

(wₘ+w_{R}+w_{c}=1) (1)

pₘ=personalized p-value in mutation data
p_{R}=personalized p-value in mRNA expression data
p_{c}=personalized p-value in CNV data
wₘ=percentiled QC measure in mutation data
w_{R}=percentiled QC measure in mRNA expression data
w_{c}=percentiled QC measure in CNV data

As is evident by Equation (1), the index standardization unit 310 applies (reflects) a weight corresponding to a conference value wₘ of a mutation biological data group in an index p-value pₘ estimated from the biological data group. Similarly, the index standardization unit 310 also applies weights corresponding to confidence values w_{R} and w_{C} of a mRNA expression biological data group and a CNV biological data group in indices p_{R} and p_{C} estimated from the biological data groups, respectively.

The combined index generation unit 300 then multiplies the weighted indices in order to generalize the indices and generates a combined index p_{combine}.

In this case, if a weight (confidence value) cannot be obtained for a biological data group, a weight w is randomly set using the following Equation (2):

$$w = \frac{1}{\sqrt{number of total biological data group}} \qquad ( 2 )$$

For example, when the weight (confidence value w_{R}) cannot be obtained for the CNV biological data group in Equation (1), and three biological data groups are used in the analysis, the weight w_{R} is assumed to have a value of 1/\sqrt{3}, according to Equation (2).

Furthermore, if an index p-value cannot be estimated from a biological data group, the index p-value may be set to 1.

The apparatus 10 for analyzing personalized multi-omics data outputs a combined index p_{combine} (or p-value p_{combine}) that is obtained by combining indices for different types of biologic data groups in the manner described above.

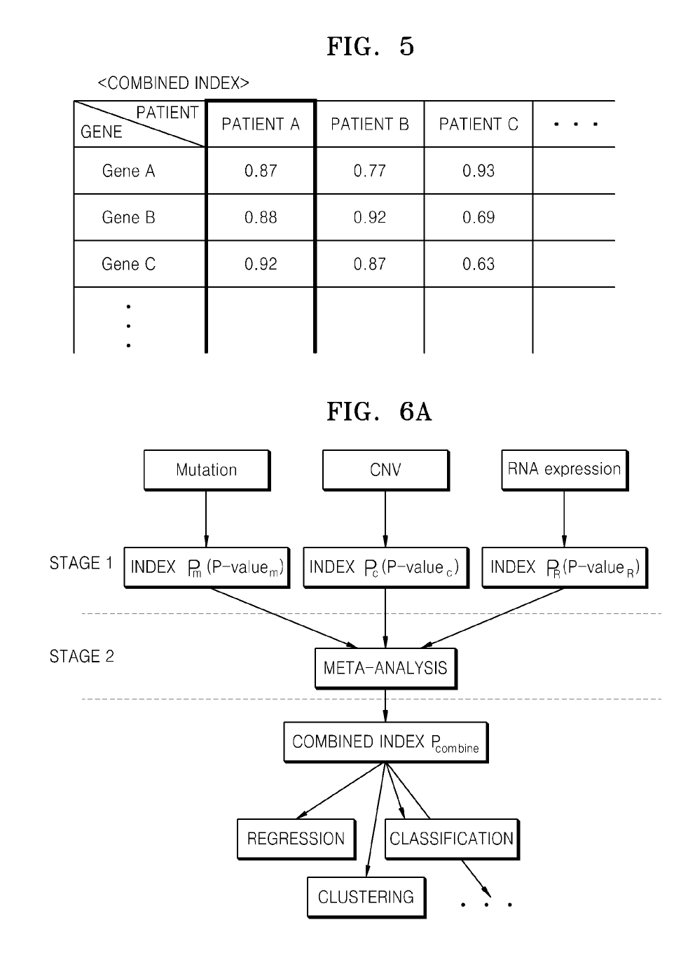

FIG. 5 illustrates a combined index p-value_{combine} according to an exemplary embodiment of the present invention. Referring to FIG. 5, the combined index p-value_{combine} may be generated by combining or merging indices for each gene. As described above, the combined index p-value_{combine} is obtained by combining indices indicating the degree of genetic abnormalities in different types of biological data groups. Thus, each of the combined indices p-value_{combine} reflects the degree of genetic abnormality in a given gene or group of genes based on all of the data available in the biological data groups.

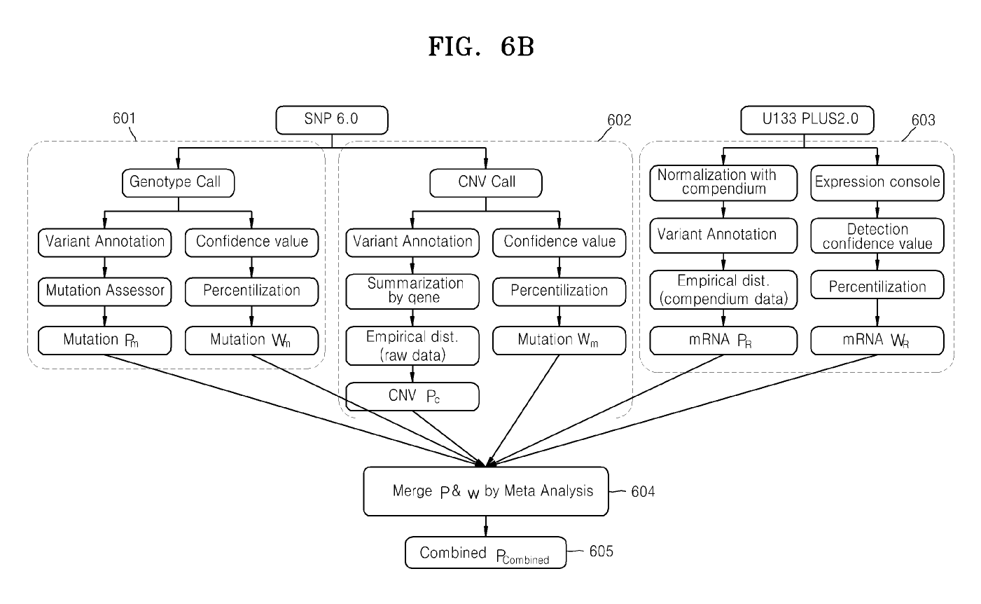

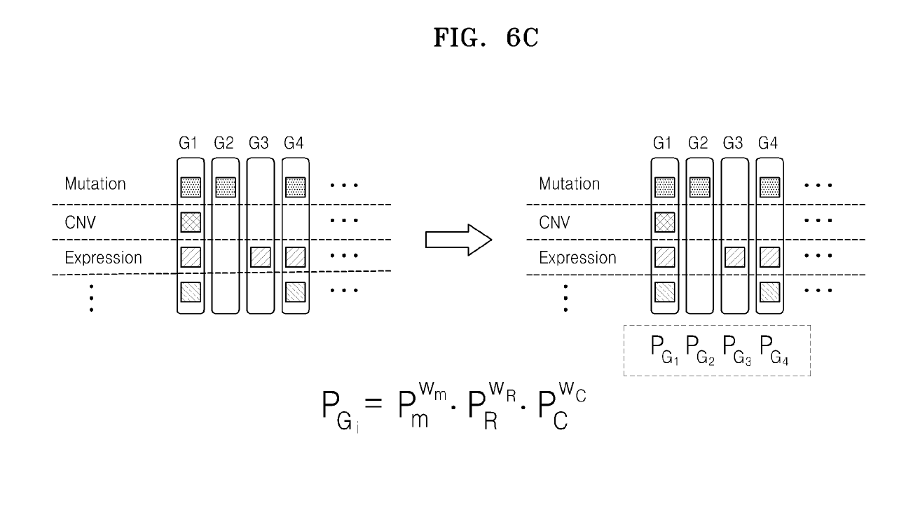

FIG. 6A is a schematic diagram for explaining a method of analyzing personalized multi-omics data according to an exemplary embodiment of the present invention. Referring to FIG. 6A, the apparatus 10 estimates indices pₘ, p_{c}, and p_{R} for mutation data, CNV data, and mRNA expression data. The apparatus 10 then generalizes or combines the estimated indices pₘ, p_{c}, and p_{R} using a meta-analysis algorithm, and outputs a combined index p_{combine} (or p-value_{combine}).

The combined index p_{combine} may be used as input data for a variety of different purposes, such as regression analysis, gene classification, and/or gene clustering analysis. For instance, it may be used to analyze the relationship between a receptor, such as c-MET, and oncogene, thereby allowing precise diagnostics for c-MET in patients with cancer. The method and apparatus described herein is believed to be particularly useful as a companion diagnostic for a particular course of therapy (e.g., anti-c-Met therapy). Thus, the method described herein may further comprise administering a therapeutic agent, particularly an anti-cancer agent (e.g., a c-Met antagonist), before or after performing the method.

FIG. 6B is a diagram more fully explaining a method of analyzing personalized multi-omics data, according to an exemplary embodiment of the present invention. Referring to FIG. 6B, the apparatus 10 estimates an index pₘ for mutation data (601), an index p_{c} for CNV data (602), and an index p_{R} for mRNA expression data (603). The apparatus 10 may perform operations 601 through 603 in parallel. In this case, as an example of meta-analysis, the apparatus 10 may use weights wₘ, w_{c} and w_{R} based on confidence values together.

Thereafter, the apparatus applies a meta-analysis algorithm to the estimated indices pₘ, p_{c}, and p_{R} to generalize or merge the indices (604). In this case, as an example of a meta-analysis, the apparatus 10 generalizes or merges the estimated indices pₘ, p_{c}, and p_{R} by applying weights wₘ, w_{c} and w_{R} based on confidence values and combining the weighted values. The apparatus 10 outputs a combined index P_{combine} (605). FIG. 6C is a diagram for explaining application of a method of analyzing personalized multi-omics data for each gene according to an exemplary embodiment of the present invention. Referring to FIG. 6C, the apparatus 10 may produce combined indices p_{G1}, p_{G2}, p_{G3}, and p_{G4} for each of the genes G1, G2, G3 and G4 using Equation (1) for calculating a combined index p_{Gi}(=p_{combine}).

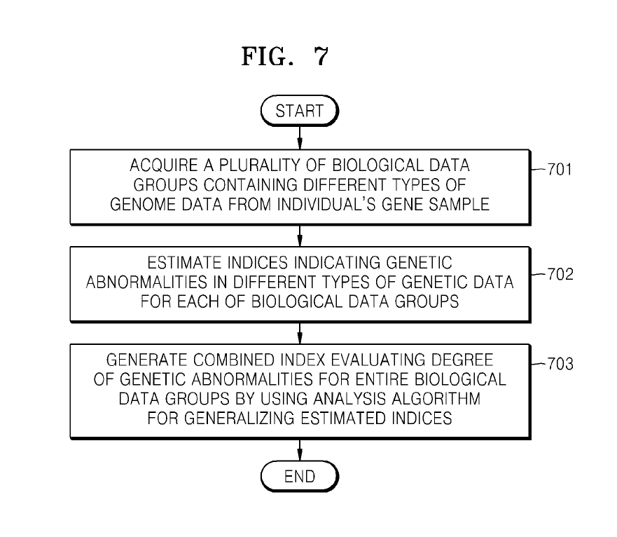

FIG. 7 is a flowchart of a method of analyzing personalized multi-omics data, according to an exemplary embodiment of the present invention. Referring to FIG. 7, the method according to the present embodiment includes operations performed by the system 1 and apparatus 10 for analyzing personalized multi-omics data in a time series manner. The details described above with reference to FIGS. 1 and 2A can be applied in the same manner to the method according to the embodiment reflected in FIG. 7.

The data acquisition unit 100 obtains a plurality of biological data groups containing different types of genome information from an individual's gene sample (701).

The index estimation unit 200 estimates an index indicating the degree of genetic abnormalities in the different types of genome information for each of the biological data groups (702).

The combined index generation unit 300 uses an analysis algorithm for generalizing the estimated indices to generate a combined index for evaluating genetic abnormalities for the entire biological data groups (703).

The above embodiments of the present invention may be recorded in programs (non-transient computer readable medium) that can be executed on a computer and be implemented through general purpose digital computers that can run the programs using a computer readable recording medium. Data structures described in the above embodiments may be recorded on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of analyzing personalized multi-omics data, the method comprising:
acquiring a plurality of biological data groups containing different types of genome data from an individual's gene sample;
estimating indices indicating a degree of genetic abnormalities in each of the different types of genomic data for each of the plurality of biological data groups; and
generating a combined index which evaluates the degree of genetic abnormalities for the entire biological data groups by using an analysis algorithm for generalizing the estimated indices.

2. The method of claim 1, wherein in the generating of the combined index, the combined index is generated by reflecting a confidence value for each of the plurality of biological data groups in the estimated indices and generalizing the estimated indices.

3. The method of claim 2, wherein the confidence value is based on a quality score produced by genome data measurement platforms used to obtain the plurality of biological data groups.

4. The method of claim 2, wherein the generating of the combined index comprises reflecting confidence values in the estimated indices to normalize the estimated indices and generalizing the normalized indices by using the analysis algorithm to produce the combined index, and
wherein the combined index is generated based on the produced combined index.

5. The method of claim 1, wherein at least one of the estimating of the indices and the generating of the combined index is performed by processing the genome data within the biological data groups for each gene.

6. The method of claim 1, wherein in the generating of the combined index, the estimated indices are merged by using meta-analysis designed for producing a value representative of the estimated indices.

7. The method of claim 1, wherein the generating of the combined index comprises applying a weight corresponding to a confidence value for each of the plurality of biological data groups to the estimated indices in order to convert the estimated indices and merging the converted indices to produce the combined index, and
wherein the combined index is generated using the produced combined index.

8. The method of claim 1, wherein in the estimating of the indices, the indices are estimated by statistically comparing each of the genome data in the biological data groups with a corresponding control group.

9. The method of claim 9, wherein the control group is obtained from a public database corresponding to each of the plurality of biological data groups.

10. The method of claim 9, wherein the estimating of the indices is performed by comparing the genome data with the corresponding control groups by using a normal distribution.

11. The method of claim 9, wherein the estimating of the indices is performed by comparing the genome data with the corresponding control groups by using an empirical distribution.

12. The method of claim 9, wherein the estimating of the indices is performed by comparing genome data in each of the biological data groups with its corresponding control group by using the same type of distribution.

13. The method of claim 1, wherein at least one of the estimated indices and the generated combined index are an index for statistically testing the significance with respect to the degree of genetic abnormalities.

14. The method of claim 1, wherein the acquired biological data groups are different types of omics data originating from the gene sample.

15. A method of analyzing personalized multi-omics data, the method comprising:
estimating indices indicating a degree of genetic abnormalities for each of a plurality of different biological data groups obtained from an individual's gene sample;
obtaining a confidence value for each of the plurality of biological data groups from genome data measurement platforms used to obtain the plurality of biological data groups; and
reflecting the confidence values in the estimated indices to generalize the estimated indices and generating a combined index which evaluates the degree of genetic abnormalities for the entire biological data groups.

16. A non-transitory computer-readable recording medium having recorded thereon a program for executing the method of claim 1.

17. An apparatus for analyzing personalized multi-omics data, the apparatus comprising:
a data acquisition unit for acquiring a plurality of biological data groups containing different types of genome data from an individual's gene sample;
an index estimation unit for estimating indices indicating a degree of genetic abnormalities in each of the different types of genomic data for each of the plurality of biological data groups; and
a combined index generation unit for generating a combined index which evaluates the degree of genetic abnormalities for the entire biological data groups by using an analysis algorithm for generalizing the estimated indices.

18. The apparatus of claim 17, wherein the combined index generation unit includes an index normalizer reflecting confidence values in the estimated indices to normalize the estimated indices and a combined index producer generalizing the normalized indices by using the analysis algorithm and producing the combined index, and
wherein the combined index is generated based on the produced combined index.

19. The apparatus of claim 18, wherein the confidence values are based on quality scores produced by genome data measurement platforms used to obtain the plurality of biological data groups.

20. The apparatus of claim 17, wherein the combined index generation unit merges the estimated indices by using meta-analysis designed for producing a value representative of the estimated indices.

21. The apparatus of claim 17, wherein the combined index generation unit includes an index normalizer for applying a weight corresponding to a confidence value for each of the plurality of biological data groups to the estimated indices and converting the estimated indices, and a combined index producer for merging the converted indices and producing the combined index, and
wherein the combined index is generated using the produced combined index.

22. The apparatus of claim 17, wherein the index estimation unit estimates the indices by statistically comparing each of the genome data in the biological data groups with a corresponding control group.

23. An apparatus for analyzing personalized multi-omics data, the apparatus comprising:
an index estimation unit for estimating indices indicating the degree of genetic abnormalities for each of a plurality of different biological data groups obtained from an individual's gene sample;
a data acquisition unit for obtaining a confidence value for each of the plurality of biological data groups from genome data measurement platforms used to obtain the plurality of biological data groups; and
a combined index generation unit for reflecting the confidence values in the estimated indices to generalize the estimated indices and generating a combined index which evaluates the degree of genetic abnormalities for the entire biological data groups.
